(19) United States
(12) Patent Application Publication
(10) Pub. No.: US 2018/0112546 A1
(43) Pub. Date: Apr. 26, 2018

(54) STATOR VANE DAMPENING SYSTEM USABLE WITHIN A TURBINE ENGINE

(71) Applicant: Siemens Aktiengesellschaftü, München (DE)

(72) Inventor: Elliot G. Griffin, Winter Springs, FL (US)

(21) Appl. No.: 15/553,194

(22) PCT Filed: Mar. 17, 2015
(86) PCT No.: PCT/US2015/020855

§ 371 Date: Aug. 24, 2017

(51) Int. Cl. F01D 9/04; F01D 25/24

(52) U.S. Cl. CPC F01D 9/042; F01D 25/24; F05D 2260/30; F05D 2240/12; F05D 2220/32

(57) ABSTRACT

A stator assembly (10) usable in a gas turbine engine (12) and configured to restrain inner and outer endwalls (14, 16) to limit deflection, provide mechanical dampening and prevent clearance loss relative to adjacent blade rotor disks is disclosed. The stator assembly (10) may be formed from a plurality of stator vanes (20) with inner and outer endwalls (14, 16) that are coupled together with a first radially outer tie bar (22) and a first radially inner tie bar (23). In at least one embodiment, first and second radially outer tie bars (22, 24) and first and second radially inner tie bars (23, 25) may form first and second stator vane segments (26, 28) that together form the circumferentially extending stator assembly (10). The inner and outer endwalls (14, 16) may be coupled together with one or more circumferentially extending alignment pins that limit deflection. The stator assembly (10) may include one more deformable seals (52, 102) extending radially inward from the inner endwall (14).

### FIELD OF THE INVENTION

This invention is directed generally to stator vane airfoils within gas turbine engines, and more particularly to dampening systems for stator vane airfoils.

### BACKGROUND

Turbine engines typically include a plurality of rows of stationary compressor stator vanes extending radially inward from a shell and include plurality of rows of rotatable compressor blades attached to a rotor assembly for turning the rotor. Conventional turbine engines often include a segment with multiple stationary airfoils collectively referred to as a stator. Stator segments deflect in the upstream direction under steady gas pressure loading, and the deflection varies around the circumference dependent upon how the segment is constrained to the casing. The unconstrained ends of the segment deflect more and have less axial clearance to the upstream rotor disk. Such problem has been addressed in U.S. Pat. No. 8,128,354 B2, but requires at least thirteen custom made components and at least twenty two steps to assemble the stator. Thus, a need exists to control deflection and alignment of the stator vane airfoils forming the stator in a more efficient manner.

### SUMMARY OF THE INVENTION

A stator assembly usable in a gas turbine engine and configured to restrain inner and outer endwalls to limit deflection, provide mechanical dampening and prevent clearance loss relative to adjacent blade rotor disks is disclosed. The stator assembly may be formed from a plurality of stator vanes with inner and outer endwalls that are coupled together with a first radially outer tie bar and a first radially inner tie bar. In at least one embodiment, first and second radially outer tie bars and first and second radially inner tie bars may form first and second stator vane segments that together form the circumferentially extending stator assembly of a circumferentially extending row of stator vanes. The inner and outer endwalls may be coupled together with one or more circumferentially extending alignment pins that limit deflection. The stator assembly may include one more deformable seals extending radially inward from the inner endwall, whereby the deformable seal may include an upstream facing contact surface and radially inward facing contact surface.

In at least one embodiment, the stator assembly for a gas turbine engine may include a plurality of stator vanes, each formed from a generally elongated airfoil having a leading edge, a trailing edge, a pressure side, a suction side, an inner endwall coupled to a first end and an outer endwall coupled to a second end opposite the first end. The stator assembly may also include a first radially outer tie bar coupled to each outer endwall of a first portion of the stator vanes and one or more inner alignment pins extending between adjacent inner endwalls to couple adjacent inner endwalls together. The stator assembly may also include a first radially inner tie bar coupled to each outer endwall of the first portion of the stator vanes. The stator assembly may include one or more inner alignment pins extending between adjacent inner endwalls to couple adjacent inner endwalls together. The stator assembly may also include one or more alignment pins extending between adjacent outer endwalls to couple adjacent outer endwalls together.

In at least one embodiment, the inner alignment pin may include one or more circumferentially extending forward inner alignment pins and one or more circumferentially extending aft inner alignment pins. The circumferentially extending forward inner alignment pin may be positioned forward of the generally elongated airfoil and the at least one circumferentially extending aft inner alignment pin may be positioned aft of the generally elongated airfoil.

In at least one embodiment, outer alignment pin may include one or more circumferentially extending forward outer alignment pins and one or more circumferentially extending aft outer alignment pins. The circumferentially extending forward outer alignment pin may be positioned forward of the generally elongated airfoil and the circumferentially extending aft outer alignment pin may be positioned aft of the generally elongated airfoil.

The first radially outer tie bar may be positioned within a recess in a radially outer surface the outer endwall. In at least one embodiment, the stator assembly may include a second radially outer tie bar coupled to each outer endwall of remaining stator vanes in a circumferential row not attached to the first radially outer tie bar, thereby forming a first stator vane segment and a second stator vane segment that together form the circumferentially extending stator assembly. The stator assembly may also include a second radially inner tie bar coupled to each inner endwall of remaining stator vanes in a circumferential row not attached to the first radially inner tie bar, thereby forming a first stator vane segment and a second stator vane segment that together form the circumferentially extending stator assembly.

The stator assembly may include one or more anti-rotation slots positioned in at least one of two interfaces between the first and second stator vane segments. The stator assembly may include one or more forward deformable seals coupled to at least one radially inner surface of the inner endwall forward of the at least one inner alignment pin. The forward deformable seal may be coupled to the radially inner surface forward of at least one forward inner alignment pin. The deformable seal may include an upstream facing contact surface and radially inward facing contact surface. The stator assembly may also include one or more aft deformable seals coupled to a radially inner surface of the inner endwall aft of the at least one inner alignment pin. The aft deformable seal may be coupled to the radially inner surface aft of at least one aft inner alignment pin.

In at least one embodiment, the stator vanes may be integrally formed with the inner endwall and outer endwall. In at least one embodiment, each of the stator vanes are integrally formed with the inner endwall and outer endwall.

An advantage of the stator assembly is that the stator assembly may provide mechanical dampening of the stator assembly.

Another advantage of the stator assembly is that the stator assembly may eliminate leakage due to segmentation in conventional stator assemblies.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of compressor stator vane segment within a gas turbine engine.

FIG. 2 is a cross-sectional view of a compressor stator vane segment within a gas turbine engine taken at section line 2-2 in FIG. 1.

FIG. 3 is a perspective detail view of a stator assembly within a gas turbine engine taken at detail line 3-3 in FIG. 2.

FIG. 4 is a cross-sectional view of an airfoil of the stator assembly taken along section line 4-4 in FIG. 3.

### DETAILED DESCRIPTION OF THE INVENTION

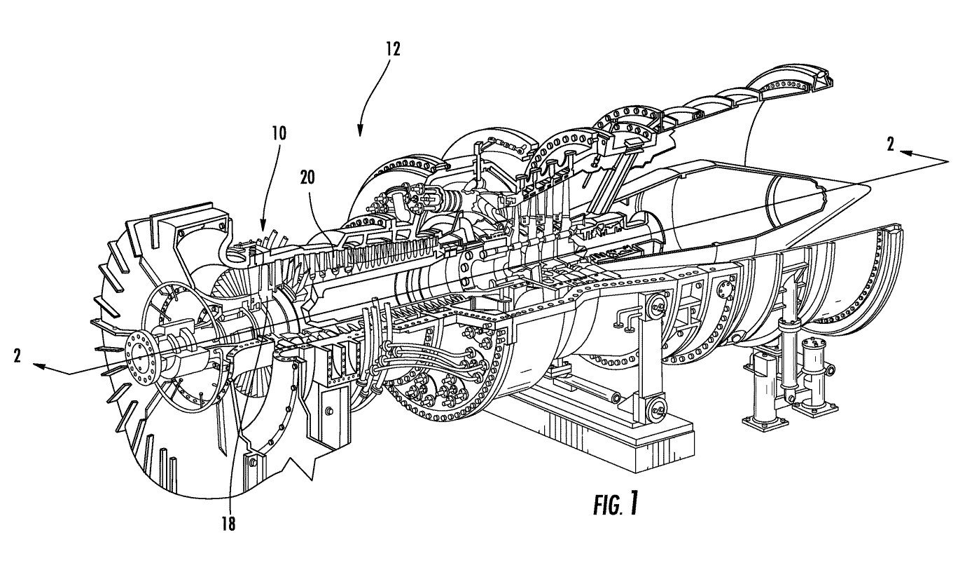

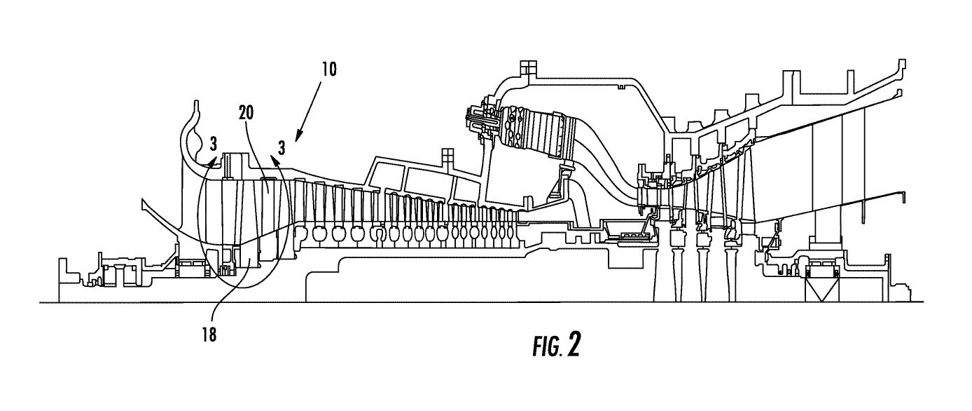

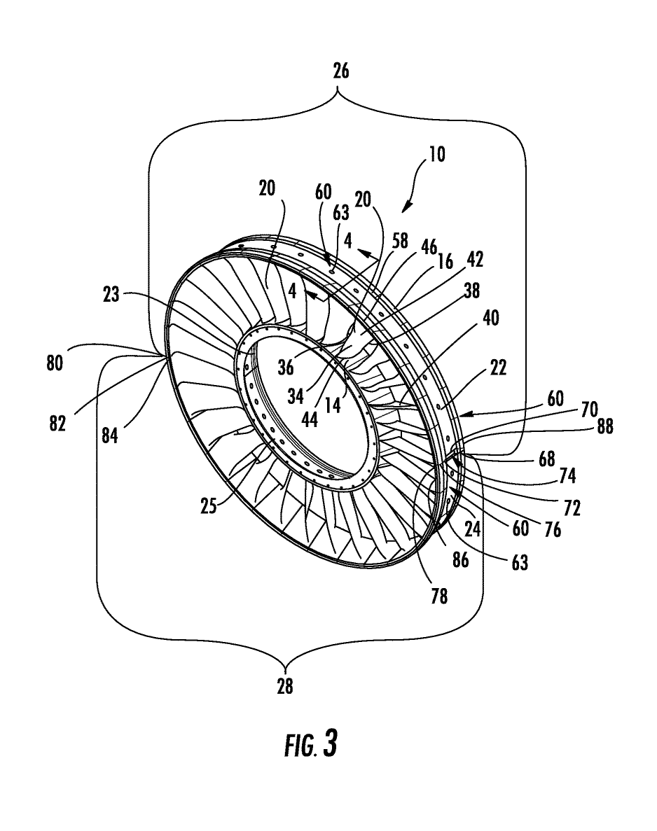

As shown in FIGS. 1-4, a stator assembly 10 usable in a gas turbine engine 12 and configured to restrain inner and outer endwalls 14, 16 to limit deflection, provide mechanical dampening and prevent clearance loss relative to adjacent blade rotor disks 18 is disclosed. The stator assembly 10 may be formed from a plurality of stator vanes 20 with inner and outer endwalls 14, 16 that are coupled together with a first radially outer tie bar 22 and a first radially inner tie bar 23. In at least one embodiment, first and second radially outer tie bars 22, 24 and first and second radially inner tie bars 23, 25, as shown in FIG. 3, may form first and second stator vane segments 26, 28 that together form the circumferentially extending stator assembly 10 of a circumferentially extending row of stator vanes 20. The inner and outer endwalls 14, 16 may be coupled together with one or more circumferentially extending alignment pins 30 that limit deflection. The stator assembly 10 may include one more deformable seals 52 extending radially inward from the inner endwall 14.

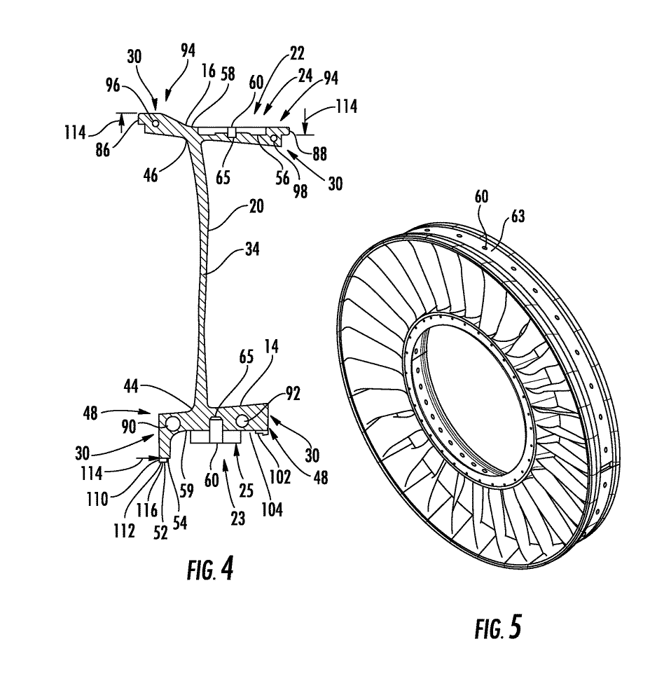

In at least one embodiment, the stator assembly 10 for a gas turbine engine 12 may be formed from a plurality of stator vanes 20, as shown in FIG. 3, each formed from a generally elongated airfoil 34 having a leading edge 36, a trailing edge 38, a pressure side 40, a suction side 42 on an opposite side of the airfoil 34 from the pressure side 40, an inner endwall 14 coupled to a first end 44 and an outer endwall 16 coupled to a second end 46 opposite the first end 44. In at least one embodiment, one or more of the stator vanes 20 may be integrally formed with the inner endwall 14 and outer endwall 16, as shown in FIG. 4. In yet another embodiment, each of the stator vanes 20 may be integrally formed with the inner endwall 14 and outer endwall 16. The generally elongated airfoil 34 may be removed and replaced without welding.

The stator assembly 10 may include a first radially outer tie bar 22 may be coupled to each outer endwall 16 of at least a portion of the stator vanes 20. The first radially outer tie bar 22 may be positioned within a recess 56 in a radially outer surface 58 the outer endwall 16. The first radially outer tie bar 22 may be attached to the outer endwall 16 via one or more connectors 60. In at least one embodiment, as shown in FIG. 3, one or more connectors 60 may be positioned at or near a circumferential midpoint 63 of the outer endwall 16. In at least one embodiment, the stator assembly 10 may include only a single connector 60 for attaching the first radially outer tie bar 22 to the outer endwall 16. In another embodiment, the connector 60 may be formed from a plurality of connectors 60 attaching the first radially outer tie bar 22 to the outer endwall 16. In at least one embodiment, the at least one connector 60 may be formed from, but is not limited to, one or more bolts, screws, rivets, pins and other connectors already existing or yet to be conceived. As shown in FIGS. 3 and 4, the first radially outer tie bar 22 may be attached to the outer endwall 16 via a single connector pin 60 at a circumferential midpoint 63 of the outer endwall 16 and at an axial midpoint 65 of the first radially outer tie bar 22.

The stator assembly 10 may also include a second radially outer tie bar 24 coupled to each outer endwall of remaining stator vanes 20 not attached to the first radially outer tie bar 22 to form a second stator vane segment 28. Similarly, the first radially outer tie bar 22 may couple together a plurality of stator vanes 20 to form the first stator vane segment 26 in a circumferential row. The first and second radially outer tie bars 22, 24 form the first stator vane segment 26 and the second stator vane segment 28, which together form the circumferentially extending stator assembly 10. In at least one embodiment, the first and second stator vane segments 26, 28 may each form one half of the stator assembly 10 forming a circumferential row and may be coupled together at a horizontal midpoint 68. The first and second stator vane segments 26, 28 may have other configurations in other embodiments.

The stator assembly 10 may include a first radially inner tie bar 23 may be coupled to each inner endwall 14 of at least a portion of the stator vanes 20. The first radially inner tie bar 23 may be positioned on a radially inner surface 59 of the inner endwall 14. The first radially inner tie bar 23 may be attached to the inner endwall 14 via one or more connectors 60. In at least one embodiment, as shown in FIG. 3, one or more connectors 60 may be positioned at or near a circumferential midpoint 63 of the inner endwall 14. In at least one embodiment, the stator assembly 10 may include only a single connector 60 for attaching the first radially inner tie bar 23 to the inner endwall 14. In another embodiment, the connector 60 may be formed from a plurality of connectors 60 attaching the first radially inner tie bar 23 to the inner endwall 14. In at least one embodiment, the at least one connector 60 may be formed from, but is not limited to, one or more bolts, screws, rivets, pins and other connectors already existing or yet to be conceived. As shown in FIGS. 3 and 4, the first radially inner tie bar 23 may be attached to the inner endwall 14 via a single connector pin 60 at a circumferential midpoint 63 of the outer endwall 16 and at an axial midpoint 65 of the first radially inner tie bar 23.

The stator assembly 10 may also include a second radially inner tie bar 25 coupled to each outer endwall of remaining stator vanes 20 not attached to the first radially inner tie bar 23 to form a second stator vane segment 28. Similarly, the first radially inner tie bar 23 may couple together a plurality of stator vanes 20 to form the first stator vane segment 26 in a circumferential row. The first and second radially inner tie bars 23, 25 form the first stator vane segment 26 and the second stator vane segment 28, which together form the circumferentially extending stator assembly 10. In at least one embodiment, the first and second stator vane segments 26, 28 may each form one half of the stator assembly 10 of a circumferential row of stator vanes 20 and may be coupled together at a horizontal midpoint 68. The first and second stator vane segments 26, 28 may have other configurations in other embodiments.

The stator assembly 10 may also include one or more anti-rotation slots 70, as shown in FIG. 3, positioned in at least one of two interfaces 72 between the first and second stator vane segments 26, 28. The stator assembly 10 may include a first anti-rotation slot 74 positioned at a first interface 76 between the first and second stator vane segments 26, 28 on a first side 78 of the stator assembly 10 and a second anti-rotation slot 80 positioned on at a second interface 82 between the first and second stator vane segments 26, 28 on a second side 84 of the stator assembly 10, which is on a generally opposite side of the stator assembly 10 from the first side 78. The anti-rotation slot 70 may extend at least partially into both of the first and second stator vane segments 26, 28. The anti-rotation slot 70 may not extend to an upstream edge 86 of the outer endwall 16 or to a downstream edge 88 of the outer endwall 16.

The stator assembly 10 may also include one or more inner alignment pins 48 extending between adjacent inner endwalls 14 to couple adjacent inner endwalls 14 together, as shown in FIG. 4. In at least one embodiment, the inner alignment pin 48 may be formed from one or more circumferentially extending forward inner alignment pins 90 and one or more circumferentially extending aft inner alignment pins 92. The circumferentially extending forward inner alignment pin 90 may be positioned forward of the generally elongated airfoil 34 and the circumferentially extending aft inner alignment pin 92 may be positioned aft of the generally elongated airfoil 34.

The stator assembly 10 may also include one or more outer alignment pins 94 extending between adjacent outer endwalls 16 to couple adjacent outer endwalls 16 together. In at least one embodiment, the outer alignment pin 94 may be formed from one or more circumferentially extending forward outer alignment pins 96 and one or more circumferentially extending aft outer alignment pins 98. The circumferentially extending forward outer alignment pin 96 may be positioned forward of the generally elongated airfoil 34 and the circumferentially extending aft outer alignment pin 98 may be positioned aft of the generally elongated airfoil 34.

The stator assembly 10 may include one or more forward deformable seals 52. In at least one embodiment, the forward deformable seals 52 may be attached to one or more radially inner surfaces 54 of the inner endwall 14 of the forward inner seal ring 50, as shown in FIG. 4. In at least one embodiment, the forward deformable seal 52 may be removable. The deformable seal 52 may include an upstream facing contact surface 110 and radially inward facing contact surface 112, as shown in FIG. 4. The upstream facing contact surface 110 may accommodate contact with an upstream rotor disk 18 without risk of mechanical distress or thermal damage to either component. Contact can occur when forces are applied via arrows 114 resulting from gas loading of vanes and pressure on the forward and aft inner seal rings 50, 100. The deformable seal 52 may be, but is not limited to being, a honeycomb shaped seal. In at least one embodiment, deformable seal 52 may be attached to the inner endwall 14 forward of the forward inner alignment pin 90. One or more coatings 116 may be applied to the deformable seal 52, such as, but not limited to, the upstream facing contact surface 110 or the radially inward facing contact surface 112, or both, to restore the sealing once the deformable seal 52 has been subjected to wear.

The stator assembly 10 may include one or more aft deformable seals 102 attached to a radially inner surface 104 of the inner endwall 14. In at least one embodiment the aft deformable seal 102 may be coupled to the inner endwall 14 aft of the aft inner alignment pin 92. The deformable seal 102 coupled to the aft inner seal ring 100 may be a honeycomb shaped seal or other seal.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A stator assembly (10) for a gas turbine engine (12), characterized in that:
a plurality of stator vanes (20), each formed from a generally elongated airfoil (34) having a leading edge (36), a trailing edge (38), a pressure side (40), a suction side (42), an inner endwall (14) coupled to a first end (44) and an outer endwall (16) coupled to a second end (46) opposite the first end (44);
a first radially outer tie bar (22) coupled to each outer endwall (16) of a first portion of the stator vanes (20);
a first radially inner tie bar (23) coupled to each outer endwall (16) of the first portion of the stator vanes (20);
at least one inner alignment pin (48) extending between adjacent inner endwalls (14) to couple adjacent inner endwalls (14) together; and
at least one outer alignment pin (94) extending between adjacent outer endwalls (16) to couple adjacent outer endwalls (16) together.

2. The stator assembly (10) of claim 1, characterized in that the at least one inner alignment pin (48) comprises at least one circumferentially extending forward inner alignment pin (90) and at least one circumferentially extending aft inner alignment pin (92).

3. The stator assembly (10) of claim 2, characterized in that the at least one circumferentially extending forward inner alignment pin (90) is positioned forward of the generally elongated airfoil (34) and the at least one circumferentially extending aft inner alignment pin (92) is positioned aft of the generally elongated airfoil (34).

4. The stator assembly (10) of claim 1, characterized in that the at least one outer alignment pin (94) comprises at least one circumferentially extending forward outer alignment pin (96) and at least one circumferentially extending aft outer alignment pin (98).

5. The stator assembly (10) of claim 4, characterized in that the at least one circumferentially extending forward outer alignment pin (96) is positioned forward of the generally elongated airfoil (34) and the at least one circumferentially extending aft outer alignment pin (98) is positioned aft of the generally elongated airfoil (34).

6. The stator assembly (10) of claim 1, characterized in that the first radially outer tie bar (22) is positioned within a recess (56) in a radially outer surface the outer endwall (16).

7. The stator assembly (10) of claim 1, further characterized in that a second radially outer tie bar (24) coupled to each outer endwall (16) of remaining stator vanes (20) in a circumferential row not attached to the first radially outer tie bar (22), thereby forming a first stator vane segment (26) and a second stator vane segment (28) that together form the circumferentially extending stator assembly (10).

8. The stator assembly (10) of claim 7, further characterized in that at least one anti-rotation slot (74) positioned in at least one of two interfaces between the first and second stator vane segments (26, 28).

9. The stator assembly (10) of claim 1, further characterized in that a second radially inner tie bar (25) coupled to each inner endwall (14) of remaining stator vanes (20) in a circumferential row not attached to the first radially inner tie bar (23), thereby forming a first stator vane segment (26) and a second stator vane segment (28) that together form the circumferentially extending stator assembly (10).

10. The stator assembly (10) of claim 1, further characterized in that at least one forward deformable seal (52) coupled to at least one radially inner surface (54) of the inner endwall (14) forward of the at least one inner alignment pin (48), wherein the at least one forward deformable seal (52) includes an upstream facing contact surface (110) and radially inward facing contact surface (112).

11. The stator assembly (10) of claim 10, characterized in that the forward deformable seal (52) may be coupled to the radially inner surface (54) forward of at least one forward inner alignment pin (90).

12. The stator assembly (10) of claim 1, further characterized in that at least one aft deformable seal (102) coupled to a radially inner surface (104) of the inner endwall (14) aft of the at least one inner alignment pin (48).

13. The stator assembly (10) of claim 12, characterized in that the aft deformable seal (102) may be coupled to the radially inner surface (104) aft of at least one aft inner alignment pin (92).

14. The stator assembly (10) of claim 1, characterized in that at least one of the stator vanes (20) is integrally formed with the inner endwall (14) and outer endwall (16).

15. The stator assembly (10) of claim 14, characterized in that each of the stator vanes (20) are integrally formed with the inner endwall (14) and outer endwall (16).
